(19) United States
(12) Patent Application Publication
(10) Pub. No.: US 2005/0209905 A2
(43) Pub. Date: Sep. 22, 2005

(54) Environmental Performance Assessment

(76) Inventors: James Neil NESS, Brisbane, Queensland (AU); Terence Peter DE LACY, Highgate Hill (AU); John Ashley SCOTT, Windsor, Ontario (CA); Graeme Leonard WORBOYS, Gilmore, Australian Capital Territory (AU)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/468,668

(22) Filed: Jan. 8, 2004

(30) Foreign Application Priority Data
Feb. 19, 2002 (WO) PCT/AU02/00173

(51) Int. Cl. G06F 17/60

(52) U.S. Cl. 705/10

(57) ABSTRACT

Abstract of the Disclosure

The present invention provides a method of assessing the sustainability performance of an entity. This is achieved by monitoring the operation of the entity, and using this to determine one or more sustainability indicators, each sustainability indicator being a respective value determined based on the operation of the entity. The sustainability indicators are then compared to respective thresholds allowing the sustainability performance to be determined in accordance with the results of the comparison.

### Detailed Description of the Invention

### BACKGROUND OF THE INVENTION

The present invention relates to a method of assessing the sustainability performance of an entity, and in particular, to a method of certifying entities that attain predetermined sustainability standards.

### DESCRIPTION OF THE PRIOR ART

The reference to any prior art in this specification is not, and should not be taken as, an acknowledgement or any form of suggestion that the prior art forms part of the common general knowledge in Australia.

In recent years there has been a move by many companies to improve their environmental and sustainable policies, thereby making the companies more responsible. The driving force behind this is the realisation that many consumers are willing to sacrifice cost savings when purchasing products or services that they perceive to be more environmentally responsible.

Thus, for example, market surveys in the US have shown that on average, US citizens will pay an additional $19.00 per person for holidays at environmentally friendly locations than other normal locations.

Accordingly, appreciating this companies have been attempting to make themselves more responsible, for example by changing operation procedures to reduce energy and water consumption, and to produce less waste.

A major problem with this however is that there is currently no simple way of determining how environmentally friendly an entity, such as a company is. In particular, whilst the company may assert that they are environmentally friendly, the consumer themselves have very little evidence of this, and therefore have to rely on trusting the company.

This situation is detrimental to both customers and companies themselves. In particular, customers can be lead into believing that companies are more responsible than is actually the case. Similarly, companies that make a large effort to improve their environmental policy have no way of demonstrating this fact absolutely to the customers. This leads to the situation where customers who are willing to pay additional funds for environmentally friendly products and services are unable to judge which products and services fulfil their requirements. This in turn will reduce the benefit of being responsible to the companies, thereby preventing a wide scale move to environmentally friendly policies.

### SUMMARY OF THE INVENTION

In a first broad form the present invention provides a method of assessing the sustainability performance of an entity, the method including:

a) Monitoring the operation of the entity;

b) Determining one or more sustainability indicators, each sustainability indicator being a respective value determined based on the operation of the entity;

c) Comparing one or more of the sustainability indicators to respective thresholds; and,

d) Generating an indication of the sustainability performance in accordance with the results of the comparison.

The sustainability indicators generally include at least one of:

a) An energy indicator representing the amount of energy used by the entity;

b) A water indicator representing the amount of water used by the entity; and,

c) A waste indicator representing the amount of waste generated by the entity.

Other indicators can alternatively be used, and in general the indicators used will depend on the nature of the entity being assessed.

Typically at least one of the sustainability indicators includes one or more component values, the sustainability indicator being determined based on a weighted sum of the component values. This is however not essential, and some indicators may be calculated directly, for example by measurement, or from utility bills, or the like.

Thus, for example, the energy indicator can be formed from one or more energy component values, each energy component value representing the amount of energy used from a respective energy source.

In this case, the method of determining the energy indicator typically includes:

a) Determining a respective energy component based on the amount of energy used from a respective source;

b) Multiplying each energy component by a respective parameter to determine a respective modified component, each parameter being predetermined in accordance with the respective energy source; and,

c) Summing each of the modified energy components.

The sustainability indicators may also include at least one of:

a) A social commitment indicator representing the impact of the entity on the local community;

b) A resource conservation indicator representing the amount of ecological products used; and,

c) A pollution indicator representing the amount of pollution to air, water and land.

In this case, the social commitment indicator may be a ratio of the number of employees living within a predetermined distance of the entity to the total number of employees. Alternatively, the social commitment indicator might be the amount of goods purchased locally as a percentage of total goods purchased. The resource conservation indicator is generally a ratio of the number of ecolabel products used to the total number of products used, while the pollution indicator might be a ratio of the amount of biodegradable chemicals used to the amount of non-biodegradable chemicals used.

The sustainability indicators may also require at least the presence and implementation of a sustainability policy.

Typically, in response to a successful comparison, the method further includes:

a) Comparing one or more of the sustainability indicators to respective second thresholds; and,

b) Generating a further indication of the sustainability performance in accordance with the results of the second comparison.

The method usually includes:

a) Comparing each indicator to a respective threshold; and,

b) Determining that the entity satisfies minimum requirements in response to a successful comparison for each indicator.

Typically each sustainability indicator is normalised relative to the size of the operation. Thus the sustainability indicators are typically calculated as either a ratio or per unit value, such as per guest at a hotel.

In this case, the method preferably includes:

a) Comparing each indicator to a normalised curve for this indicator; and,

b) Recommending improvements for each indicator in terms of this normalised curve.

The method preferably further includes certifying the entity in response to a successful determination.

Thus, the entity typically has to satisfy a number of comparisons before it is determined that the entity satisfies minimum sustainability requirements, thereby qualifying for certification. However, alternatively, each comparison could be assessed independently, so that separate certification is based on each comparison. Alternatively, the indicator values could be combined and the assessment performed on the basis of a single threshold comparison.

Typically the method includes:

a) Comparing each indicator to a respective second threshold; and,

b) Determining that the entity satisfies best practice requirements in response to a successful second comparison for each indicator.

This allows different levels of certification to be provided. It will be appreciated that any number of levels of certification may be provided as desired.

Each threshold is typically determined in accordance with at least one of:

a) The entity's location; and,

b) The nature of the entity's operation.

This allows the certification to take into account environmental factors that are location or industry specific. For example the impact of electricity generation on the environment will differ depending on how the electricity is generated. Accordingly, the effect of using electricity from the National Grid will vary depending on the entity's location. The effect of this can be handled by setting thresholds based on factors, such as the location or nature of the entity.

Each threshold may be determined in accordance with an average of the respective sustainability indicators determined for a sample number of entities, although other techniques, such as studying environmental reports, building environmental impact studies, recommendations from government or other organisations or the like.

In the case in which averages are used, the threshold can be set 5% higher than the average of the respective sustainability indicators. This allows the system to ensure that the entity must be above average to get the minimum level of certification. In this case, the second threshold can be 30% higher than the average of the respective sustainability indicators, for example.

The entity or a member of the entity may perform the monitoring. Alternatively, an accredited individual could perform the monitoring. However, generally a mixture of the two would be used, allowing for example, the member of the entity to do the initial assessment, with the accredited individual monitoring in future years.

Typically the method further includes generating a report, the report indicating the sustainability performance of the entity by indicating at least the results of the comparisons.

The report may also further indicate improvements that could be made to the operation to thereby the sustainability performance of the entity.

Typically the method is performed using a processing system including at least:

a) An input for receiving the one or more sustainability indicators;

b) A store for storing the respective thresholds; and,

c) A processor, the processor being adapted to:

i) Compare the one or more of the sustainability indicators to respective thresholds; and,

ii) Generate the indication of the sustainability performance in accordance with the results of the comparison.

In this case, the method typically further includes causing the processor to store entity data in the store, the entity data representing at least:

a) The identity of the entity; and,

b) The sustainability indicators.

The entity data may also further represent at least:

c) The location of the entity; and,

d) The nature of the entity's operation.

The method can then include determining the thresholds in accordance with the entity data stored in the store.

In a second broad form the present invention provides a system for assessing the sustainability performance of an entity, the system including:

a) An input for receiving one or more sustainability indicators, each sustainability indicator being a respective value determined based on the operation of the entity;

b) A store for storing respective thresholds; and,

c) A processor, the processor being adapted to:

i) Compare the one or more of the sustainability indicators to the respective thresholds; and,

ii) Generate the indication of the sustainability performance in accordance with the results of the comparison.

In this case, the input can be formed from a remote processing system coupled to the system via a communications network, although other forms of input could also be used.

The system can also be formed from a number of interconnected processing systems.

Typically the system is adapted to perform the method of the first broad form of the invention.

In a third broad form the present invention provides a computer program product for assessing the sustainability performance of an entity, the computer program product including computer executable code which when executed by a suitably programmed processor causes the processor to perform the method of the first broad form of the invention.

### BRIEF DESCRIPTION OF THE DRAWINGS

An example of the present invention will now be described with reference to the accompanying drawings, in which:

FIG. 1 is a schematic diagram of an example of a system for implementing the present invention;

FIG. 2 is a schematic diagram of an example of one of the processing system of FIG. 1;

FIG. 3 is a schematic diagram of an example of one of the end stations of FIG. 1;

FIG. 4 is a flow chart of an overview of the process of obtaining certification using the system of FIG. 1; and,

FIG. 5 is a flow chart of an example of the process of obtaining certification for an entity in the tourist accommodation industry, using the system of FIG. 1.

### DETAILED DESCRIPTION OF THE PREFERRED EMBODIMENTS

An example of the present invention will now be described with reference to FIG. 1, which shows a system suitable for implementing the present invention.

As shown, the system includes a base station 1 coupled to a number of end stations 3, via a communications network 2, and/or via a number of local area networks (LANs) 4. The base station 1 is generally formed from one or more processing systems 10 coupled to a data store 11, the data store 11 usually including a database 12, as shown.

In use, users of the end stations 3 can access services provided by the base station 1. These services generally include allowing entities, such as companies or individuals, to obtain environmental certification, to obtain information relating to certification and improving environmental procedures, as well as allowing third parties to access details of certified entities.

The system may be implemented using a number of different architectures. Thus, in one example, the communications network 2 is the Internet, with the LANs 4 representing private LANs, such internal LANs within a company or the like. In this case, the services provided by the base station 1 are generally made accessible via the Internet 2, and accordingly, the processing systems 10 may be capable of generating web-pages or like that can be viewed by the users of the end stations 3.

Alternatively, information can be transferred between the end station 3 and the base station 1 using other techniques as represented by the dotted line. These other techniques may include transferring data in a hard, or printed format, as well as transferring the data electronically on a physical medium, such as a floppy disk, CD-ROM, or the like, as will be explained in more detail below.

In any event, the processing systems 10 may be any form of processing system but typically includes a processor 20, a memory 21, an input/output (I/O) device 22 and an interface 23 coupled together via a bus 24, as shown in FIG. 2. The interface 23, which may be a network interface card, or the like, is used to couple the processing system to the Internet 2.

It will therefore be appreciated that the processing system 10 may be formed from any suitable processing system, which is capable of operating applications software to enable the provision of services. However, in general the processing system 10 will be formed from a server, such as a network server, web-server, or the like.

The end stations 3 must generally be capable of receiving and processing data, as well as transferring data to the base station 1 in some cases. Accordingly, in this example, as shown in FIG. 3, the end station 3 is formed from a processing system including a processor 30, a memory 31, an input/output (I/O) device 32 and an interface 33 coupled together via a bus 34. The interface 33, which may be a network interface card, or the like, is used to couple the end station 3 to the Internet 2.

It will be therefore be appreciated that the end station 3 may be formed from any suitable processing system, such as a suitably programmed PC, Internet terminal, lap-top, hand-held PC, or the like. The end station 3 may also operate applications software to enable web-browsing or the like.

Alternatively, the end station 3 may be formed from specialised hardware, such as an electronic touch sensitive screen coupled to a suitable processor and memory. In addition to this, the end station 3 may be adapted to connect to the Internet 2, or the LANs 4 via wired or wireless connections. It is also feasible to provide a direct connection between the base stations 1 and the end stations 3, for example if the system is implemented as a peer-2-peer network.

In use, the system allows users of the end stations 3 to attempt to obtain environmental certification from the base station 1. The certification may be obtained for one or a group of companies, individuals, service providers, or the like (hereinafter referred to generally as an entity).

Overview

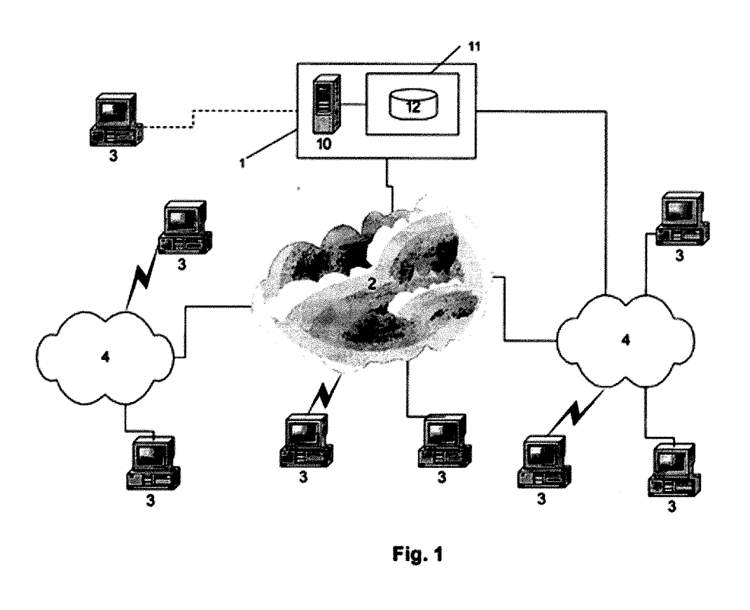

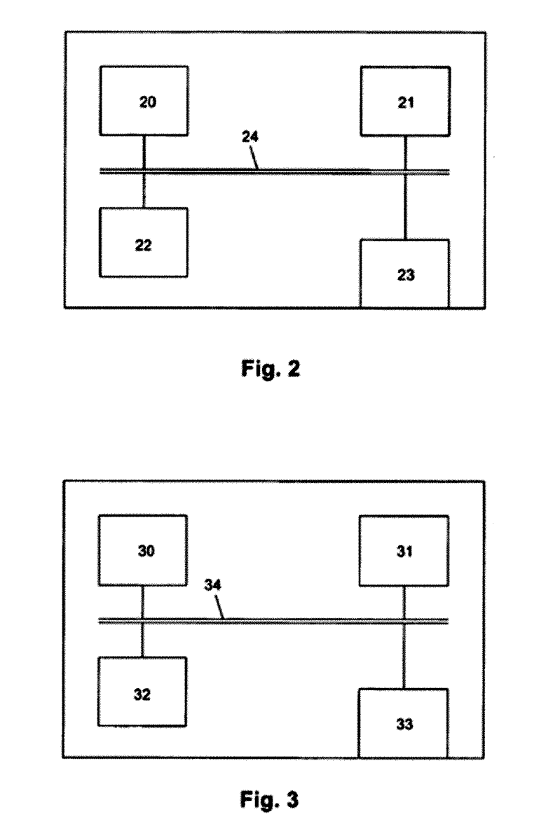

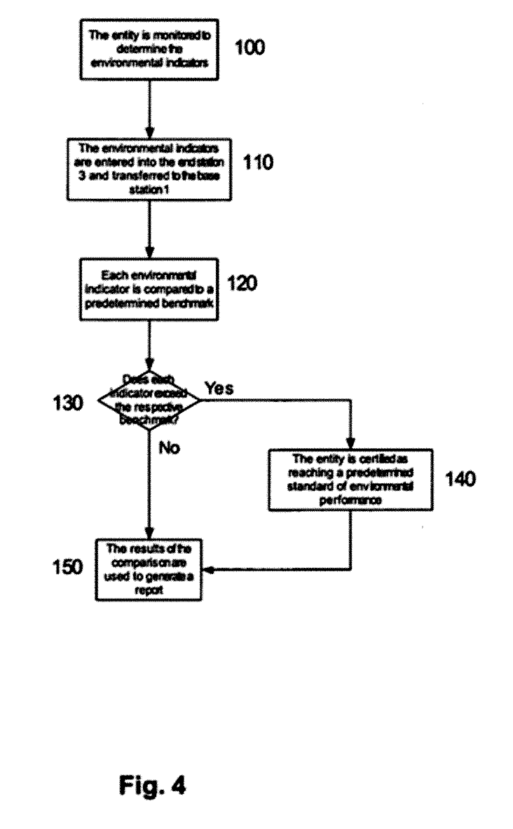

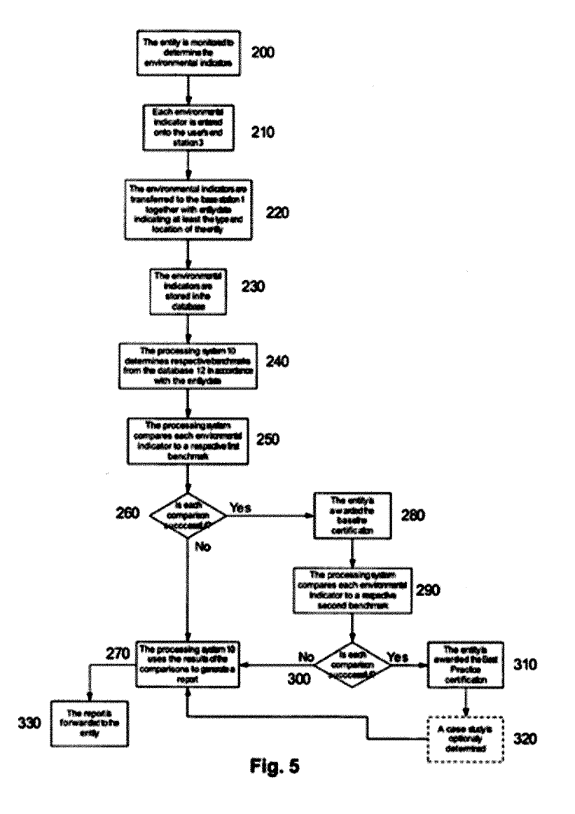

An overview of the process will now be described with reference to FIG. 4.

As shown at step 100, the first stage is for the entity to be monitored to determine a number of sustainability indicators. The sustainability indicators are a measure of the operation of the entity in a particular environmental area.

Thus for example, the sustainability indicators may include an indication of the amount of energy, such as electricity, consumed, or the amount of water consumed by the entity. Examples of sustainability indicators are shown in Appendix A.

In general, the sustainability indicators can be determined relatively easily. Thus for example, in the case of the water consumed, this can simply be measured from a water meter. In the case of determining the amount of energy consumed, the system allows users to provide information obtained from utility bills, outlining the amount of energy such as electricity, or gas, obtained from different sources. This is then added together to determine the corresponding sustainability indicator, as will be explained in more detail below.

The sustainability indicators are entered into or calculated using the end station 3, before being transferred to the base station 1 at step 110. As mentioned above, this can happen in anyone of a number of ways depending on the architecture of the implementing system.

Each sustainability indicator is then compared to a predetermined benchmark by the base station 1 at step 120. In general, the benchmark is intended to represent a minimum level of efficiency, or environmentally friendly operation that is required in order to obtain certification. As each sustainability indicator is independent, it is generally necessary to provide a distinct benchmark to correspond to each sustainability indicator.

However, in addition to this, the environmental impact of an entity's operation may vary depending on the region in which the entity is located. Thus for example, in a region where fresh water is readily available, the effects of water consumption will not have such a great impact on the environment as in regions where fresh water is typically scarce. Accordingly, the predetermined benchmarks may also be location specific.

Furthermore, it will be appreciated that different industries will require different benchmarks. In particular, it will be readily apparent that a chemical processing plant will typically require more energy and water than for example a hotel. Accordingly, the benchmarks may be set according to both the entity's type and location.

In any event, once each sustainability indicator has been compared to a respective benchmark at step 130, it is determined whether each indicator exceeds the respective benchmark. If this is the case, the entity is certified as reaching a predetermined standard of sustainability performance at step 140. Otherwise, certification is not granted.

In any event, whether certification is granted or not the results of the comparison are used to generate a report at step 150. This report can then be used by the entity to improve their sustainability performance subsequently.

### DETAILED DESCRIPTION OF A SPECIFIC EXAMPLE

A detailed description of the operation of the system of FIG. 1 will now be described. In this example, the entity will be taken to be involved in the tourist accommodation industry.

As shown at step 200, the first stage in the process is for the entity to be monitored to determine the sustainability indicators. The sustainability indicators used in this particular example, together with examples of additional sustainability indicators used in other industries are shown in appendix A.

Thus, in the tourist accommodation industry it is necessary for the respective entity to generate sustainability indicators indicating:

The presence of a sustainable environmental policy;

Energy consumption;

Potable water consumption;

Solid waste production;

Social commitment;

Resource conservation;

Cleaning chemicals used;

One optional indicator chosen from list; and,

One agreed indicator nominated by entity operator.

The exact manner in which each sustainability indicator is calculated will depend on the nature of the indicator itself. However, in general the sustainability indicators are determined by measuring the absolute usage for the entity and then normalising this value, such that the values for different sized entities may be directly compared to the same benchmark, as will be described in more detail below.

Thus, for example, in the case of water consumption, the indicator requires the calculation of the water consumed per guest night or per roof area. This can easily be calculated by determining the total amount of water used during a predetermined time period for the entire entity. This value is then normalised by dividing by the number of guests staying per night, or the total roof area, as appropriate.

Similarly, the solid waste production indicator has the calculation of the volume of waste per guest night or per area under roof. Again, this will require that the amount of solid waste produced be measured. The social commitment indicator involves determining the number of employees living within twenty kilometres and setting this as a ratio with respect of the total number of employees. The resource conservation indicator is an indication of the ratio of Ecolabel products purchased and normal products purchased, whilst the cleaning chemicals used is an indication of the ratio of the biodegradable chemicals to normal chemicals used.

The only major variations on this are the presence of a sustainable environment policy indictor, which is a yes/no indication of whether an environmental policy is in place, and the energy consumption indictor.

The energy consumption indicator is generally formed from a sum of component values, with each component value representing the energy obtained from a respective source. The reason for this is that energy generated from different sources will generally be in different units.

In order to calculate the energy consumption indicator, the user provides the component values to applications software executed by the end station 3. The applications software multiplies each entered component value by a respective parameter to ensure that each of the component values are converted into the same energy unit. These modified components are then added to calculate a total value, which is then normalised to determine the energy consumption indicator.

The parameters used are based on the calorific values of the various fuels and on the different units used to measure energy or amount of fuel consumed.

The applications software can also be adapted to use the energy component values to determine the environmental impact caused as a result of the entity's energy consumption, such as for example, to determine the amount of carbon dioxide generated.

In this case, the calculation would again sum the component values after they have multiplied by a respective parameter. In this instance however, the environmental impact will depend not only on the amount of energy used, but also on the manner in which it is generated. Accordingly, the parameters are determined based on the environmental impact of the manner in which the energy is generated.

Thus, for example, energy obtained from the national grid will typically come from exhaustible energy supplies, such as oil, coal or natural gas. As this form of energy generation typically has a large environment impact, for example by generating large amounts of CO.sub.2, the parameter will generally have a high value. In contrast, electricity obtained for example from solar power has a lower environment impact, for example as it generates less CO.sub.2, and will therefore have a much lower parameter.

Once all the sustainability indicators have been determined these are then entered onto the user's end station 3 at step 210. The sustainability indicators are transferred to the base station 1 at step 220, together with entity data indicating at least the nature and location of the entity. In the current example of tourist accommodation, the entity data would indicate tourist accommodation and the address at which the accommodation was located.

The manner in which the data is transferred from the end station 3 to the base station 1 can vary. For example, the end station 3 may be accessing a website generated by the end station 1. The website includes appropriate fields allowing the user to enter the data in their respective one of the fields, thereby transferring the data to the base station 1. Alternatively, the data could be transferred electronically in the form of an e-mail, or in the form of a file, transferred using an FTP or the like.

It is also possible for the user to transfer the information in a hard format, such as via fax, post or the like. This could be achieved by causing the end station 3 to print out each sustainability indicator together with the entity data on a sheet of paper which can then be forwarded to the base station 1 for manual input.

Once the base station 1 has received the sustainability indicators and the entity data, these are typically stored in the database 12 at step 230 for future reference, as will be described in more detail below.

In any event, at step 230 the processing system 10 operates to determine appropriate benchmarks from the database 12 in accordance with the entity data. As mentioned above the benchmarks used will depend on both the location and the nature of the entity. Accordingly, the database 12 will typically store a lookup table (LUT) which indicates for each type of entity and each entity location the respective benchmarks that should be used.

At step 240 the processing system 10 compares each sustainability indicator to a respective first benchmark.

The first benchmark generally indicates the minimum value of sustainability indicator that is acceptable. Thus, if the value of the environment locator exceeds the benchmark, this indicates that the environment policy in this particular area is unacceptable. Thus for example, if the energy exceeds a predetermined value, this indicates that the entity is using more energy than is environmentally desirable. Accordingly, in this instance the comparison would fail.

At step 260 the processing system 10 determines if each comparison is successful. If not the processing system 10 uses the results to generate a report at step 270. An example report for this example is shown in Appendix C.

Otherwise the processor moves on to step 280 and indicates that the entity has been awarded base line certification.

The processing system 10 then moves on to step 290 to compare each sustainability indicator to a respective second benchmark. The second benchmark defines stricter criteria then the first benchmark. Thus, for example, the second benchmark requires that the entity uses even less water per guest night in order for a successful comparison to be obtained.

Again, the processor determines at step 300 whether each comparison has been successful. If not, the processor proceeds to step 270 to generate a report. However, if the each comparison is successful the processing system 10 moves on to step 310 to award the entity a best practice certification before issuing the report at step 270. The processing system 10 can optionally generate a case study at step 320 as will be described in more detail below.

Once generated the report is forwarded to the entity at step 330. As shown in Appendix C, the report will generally indicate the particular sustainability indicators that are determined for the entity, together with an indication of whether each sustainability indicator satisfies both the first and second benchmark values. In the event that any certification has been awarded, an indication of this will also be included in the report.

Benchmark Calculation

Benchmarks can be calculated in a number of different ways and this will typically depend on the nature of the benchmark itself.

Typically, for example, the benchmarks are calculated by taking into account a number of different environmental and social performance areas. These typically include areas such as greenhouse gas generation, energy management, air quality, fresh water resources, waste water management, waste minimisation, social and cultural impact, land use management, ecosystem conservation.

As shown in appendix B for example, the energy consumption will generally have an impact on a greenhouse gas production, energy management, air quality, waste minimisation and ecosystem conservation.

Accordingly, it is preferable for each of these respective areas to be taken into account when generating the benchmarks.

However, it is also possible to take into account additional information, such as environmental or governmental legislation. Similarly, in the case of holiday accommodation for example, certain building standards have also been issued which can be used in the calculation of the benchmarks.

Accordingly, the calculation of the benchmarks is to a large extent a subjective procedure that will require the constant review of existing environmental policies.

However, in addition to generating the benchmarks by considering the above factors it is also possible to generate the benchmarks based on the operation of other entities of an equivalent type and location.

An example of the manner in which this is achieved is to determine sustainability indicators for a large number of entities. The value of the determined sustainability indicators are then averaged with the first benchmark being set 5% offset to the average value. Thus, in order to gain a base line certification, a company must be operating with at least a 5% greater efficiency than average.

Similarly, the best practice certification can be based on at least a 30% higher efficiency than the determined average.

In this instance, when the system is initially configured the benchmarks will have to be determined manually for example by consideration of environmental factors. However, once a suitable number of entities have submitted sustainability indicators, this will allow averages to be generated which can then be used to either create new benchmarks or modify existing benchmarks.

Accordingly, it is advantageous for each of the sustainability indicators to be stored within the database 12. The processing system 10 can then monitor the number of sustainability indicators stored for a given entity type and location and then use this to generate an average when a suitable number is available.

Additional Features

A number of additional features are also available within the present invention.

Reports

The reports can be adapted to indicate improvements that have been achieved, either in comparison to previous years, or in comparison to the benchmarks. These improvements can be compared to a normalised curve to show the improvement relative to other entities.

The generated reports can be tailored to provide the entity with an indication as to areas in which their environmental policy could be improved. Thus for example, if the energy sustainability indicator is particularly high, the report could advise the entity to not only attempt to reduce the amount of energy used, but also to obtain more energy from environmentally friendly sources.

It will be appreciated that the comments produced may be produced manually by having an operative of the base station 1 examine each report and then provide appropriate comments. Alternatively however each comment could be a selected standard comment that is downloaded from the database 1 based on differences between the sustainability indicators and the benchmarks. Thus, for example, a large difference between the sustainability indicators and the benchmarks may indicate that a large amount of work is required by the entity. As a result, the processing system 10 could supply comments addressing the major forms of environmental policy that generally result in such poor performance.

As an alternative however the operatives of the base station 1 may actually visit the entity and perform a review of the entity's procedures to provide more tailored advice.

Auditing

The above description indicates merely that the sustainability indicators are determined by monitoring the entity. However, this could be performed either by the entity, or in the case of a company a member of the company, or by an operative of the base station 1. In the first scenario it is theoretically possible for the entity to manipulate the energy indicator values to ensure that at least base line certification is achieved, for example.

However, it will typically be difficult for an entity to manipulate figures successfully on a first attempt, primarily because they will be unaware of the benchmark values. However, having submitted sustainability indicators once, the entity may be able to guess approximate values for the benchmarks and thereby manipulate sustainability indicators in future years.

In order to avoid this, the entity can be provided with a certification for one year on the basis of sustainability indicators provided by the entity itself. In this instance, to maintain the certification after one year, the entity must submit to an audit in which an operative of the base station 1 will audit the entity and review how the sustainability indicators are determined.

The operative will perform a detailed review of the entity's operation and determine sustainability indicators based thereon, which are then applied to the method outlined above. This ensures that sustainability indicator values are not manipulated by the entity thereby allowing the system to ensure that the certification is only granted when certain levels of environmental procedures are virtually achieved.

It will be appreciated that the use of an audit can be repeated at predetermined intervals as required.

Costs

Significant cost savings can be achieved by improving the efficiency of a businesses operation, which often ties in well with improving the sustainability performance. Thus for example, a reduction in the energy consumption of a company can lead to significant cost savings.

Accordingly, the present invention can be adapted to provide the user with cost indications. Cost indications can be achieved using a look-up table that stores a base cost per unit for each sustainability indicator. The system can multiply each sustainability indicator by an appropriate base cost per unit, to estimate a respective cost for the entity. Thus, for example, in the case of the energy consumption indicator, the LUT will store an indication of the average cost of one unit of the environmental energy indicator and allow this to calculate a total cost of obtaining the energy for the entity.

The entity can then be provided with evaluations, such as the reduction in costs that would be obtained if the entity were to meet either the first or second benchmarks.

In addition to this, once the entity has submitted sustainability indicators over at least two years, the system can be adapted to estimate the cost saving that has been achieved by any improvements in sustainability performance from year to year.

Case Study

In order to encourage other entities to participate in the scheme, when an entity obtains a best practice certification, the base station 1 can operate to generate a case study outlining how this has been achieved.

In particular, an operative of the base station 1 will visit the entity and assess which factors have had a major impact on obtaining the improved sustainability performance, as well as any impact this may have had on costs, or the like.

The case study can then be published by the base station 1, for example as a web page, allowing users of the end stations 3 to access the case study and view the facts of the environmental improvement.

Certification Search

The base station 1 will typically publish a list of all entities involved in the project that have achieved at least base line or best practice certification. Details of these entities will be searchable in accordance with the entity type and location, allowing consumers such as holidaymakers or the like to perform searches to locate entities that have satisfied the predetermined environmental requirements. This allows the consumers to be certain that the products and services they are obtaining come from environmentally friendly sources.

Architecture

The present invention can be implemented using a number of different architectures. The architecture described above with respect to FIG. 1 is particularly advantageous for a number of reasons.

Firstly, the benchmarks are stored centrally on the database 12. Accordingly, as benchmarks are updated, these only need to be updated at the central location 12.

Similarly, the sustainability indicators for each entity are stored centrally at the database 12. This allows benchmarks to be calculated in the manner described above. In addition to this, it allows the sustainability indicators obtained over previous years to be compared to current sustainability indicators thereby determining if improvements in performance have been obtained.

Finally, this form of configuration allows the environmental data and entity data of different companies to be retained secret whilst still allowing the data to be used by the base station 1 in calculations, such as determining benchmarks. This allows the benchmarks to be retained secret, thereby avoiding the situation in which entities attempt to manipulate figures to thereby ensure they achieve certification.

However, this is not essential for operation of the present invention. Accordingly for example, each end station could be provided with application software that includes an indication of the benchmarks.

In this case, it would not be necessary to actually use the base station 1 at all. Instead, each entity could simply enter data using their appropriate application software to allow the sustainability indicators to be compared to their respective benchmarks, on the end station 3 itself. This would thereby obviate the need for the base station 1.

However, it will be appreciated that the certification could not be controlled in this instance. Accordingly, the end station 3 could be adapted to generate an indication of whether the comparisons were successful and certification has been achieved. In this case, an indication that certification has been achieved could be transferred to a base station 1 allowing the certification to be controlled centrally.

In this case however there is a risk that the benchmarks would become public information in order to avoid this, it would generally be necessary to ensure that the benchmarks are stored in an encrypted fashion on the end station 3. Furthermore, the transfer indication of certification would also have to be transferred in an encrypted manner to prevent individuals attempted to duplicate the indication and thereby obtain certification fraudulently.

Finally, it will be appreciated that the method could be implemented by hand. However, this would not feasibly allow the benchmarks to be calculated and nor would it allow the certification to be provided in an automated fashion.

Persons skilled in the art will appreciate that numerous variations and modifications will become apparent. All such variations and modifications which become apparent to persons skilled in the art, should be considered to fall within the spirit and scope that the invention broadly appearing before described.

### APPENDIX A

Examples of some of the sustainability indicators that may be used are set out below. The example below is described with respect to the tourist accommodation industry.

Accommodation operations can be built and run to cater for different primary markets (e.g. short/long stay, conventions, sports activities etc.). As a consequence, certain indicators, such as Energy Consumption and Potable Water Consumption, take into account the primary market and functions of the operation being benchmarked.

Therefore if the operation: has less than 40% of floor space under roof set aside for nonaccommodation purposes (e.g. for offices, bars, leisure areas), these indicators will be assessed on a per guest night basis.

has more than 40% of floor space under roof set aside for non-accommodation purposes (e.g. there are large sporting or convention facilities), then these indicators can be assessed on a total area under roof (m²) basis.

Sustainability Policy

Objective: Produce a clear and straightforward written policy that addresses key sustainability issues identified in predetermined standards.

The Sustainability Policy is an operation's statement with respect to its assessment, control and where appropriate, continual improvement, of environmental and local social impacts. The areas that need to be covered are included in the predetermined standards. The base station may provide a suitable policy statement that can be adopted by operations.

Indicator measure: A Sustainability Policy has been produced, endorsed by the operation's executive officer responsible for the entity's environmental program.

Energy Consumption

Objective: Minimize overall energy consumption.

Significant levels of energy can be consumed by infrastructure (e.g. buildings, recreational facilities) and transport facilities (including customer transfer, maintenance and on-site vehicles). An overall reduction in energy consumed will have a positive impact on operational costs and can have major environmental benefits, primarily through conservation of natural resources and lowering associated greenhouse gas emissions.

Energy can be consumed from a variety of sources (e.g. grid electricity, natural gas, gasoline, diesel) and total usage is assessed on a standard energy unit basis (Gigajoules, (if). Electricity consumption is often quoted in kilowatt-hours (kWh) and in the case of other sources, such as diesel, petroleum, liquefied petroleum gas (LPG) and natural gas, by volume. All can be readily converted to joules using GREEN GLOBE supplied conversion factors.

Indicator measure: Total energy consumption (03) pal Guest nights pa or Area under roof (an') Greenhouse gas reductions: Reduction in emissions from energy production and distribution.

The long-term solution to reducing energy consumption and greenhouse gas production is to introduce more efficient, less non-renewable energy intensive equipment and procedures.

However, application of this "cleaner production" or "ecoefficiency" approach will take time. Additionally many operations in the Travel & Tourism industry are already energy efficient and/or further significant reductions in energy from non-renewable sources may not, for operational and commercial reasons, be feasible.

There may be a case, therefore, for looking for alternative strategies. One potential option is involvement in carbon sequestration as an immediate move towards off setting greenhouse gas production. Participation in such schemes can be promoted as an Operation Selected Indicator.

Many operations are making significant efforts to utilize energy from renewable sources (e.g. wind, solar, hydro), thereby conserving resources and minimizing greenhouse gas emissions. This can be also recognized through adoption of an Operation Selected Indicator that highlights the amount of renewable energy consumed pa.

Potable Water Consumption

Objective: Minimize consumption of potable water.

Potable water resources can be consumed not only by drinking, but through other activities such as washing (personal and laundry), recreational facilities, gardens and cleaning of surfaces. Many Travel & Tourism operations are also located in regions where access to fresh water is a concern. Actions leading to an overall reduction in water usage (from lowering demand and/or increasing reuse and recycle) will be a significant contribution to the local environment and the long-term sustainability of the operation.

The indicator monitors the overall efficiency of potable water usage with a view to promoting reduction without compromising the operation.

Indicator measure: Water consumed (kL) pa / Guest nights pa or Area under roof (m²)

Greenhouse gas reductions: Reduction in emissions from energy required for potable water treatment, distribution and disposal.

Solid Waste Production

Objective: Reduce the amount of solid waste generated.

Used or waste materials sent to landfills represent a loss of resources, and their replacement will increase greenhouse gases from production and transport of their replacements. The first step for the operation should be to look to reduce quantities of materials consumed (including packaging), to then consider reuse, or if not possible, recycle.

As part of the Sustainability Policy, consideration should be given to the options that have the best local environmental impact. For example, recycling may not always be feasible (e.g. no local facility) and on-site waste to energy systems may be a better route, obtaining both energy and a reduction in the volume of waste disposed (measured either as uncompacted, or mechanically compacted, material).

Indicator measure: Volume of waste landfilled (m³) pa / Guest nights pa or Area under roof (m²)

Greenhouse gas reductions: Reduction in emissions from energy required for material production, and subsequent waste transposition and disposal.

Social Commitment

Objective: Develop and maintain positive, productive and sustainable contributions to the local community.

A key issue in achieving sustainability is to consider the social as well as environmental impact of the operation with local communities. Respecting, where appropriate, local traditions and customs, and purchasing where possible local goods and services are positive contributions that can be made, and should be incorporated into the operation's Sustainability Policy. Other considerations should include active participation in local communities and organizations.

The indicator to monitor is the number of owners, managers and/or employees that have a primary address close to where they are based within the operation is used (for remote operations, such as on small non-populated islands, the nearest permanent township can be used instead of the operation). This encourages local employment and minimizes environmental impacts due to personnel transportation.

Indicator measure: Employees with theft primary address within 20 km of the operation/Total employees

Greenhouse gas reductions: Reduction in emissions from transport energy consumption.

Resource Conservation

Objective: Reduce consumption of natural resources and the impact on ecosystem biodiversity.

An active policy of purchasing supplies of materials from sources using environmentally sound ingredients and processes can be a major contribution to resource conservation and biodiversity (i.e. through less impact on the balance of the local ecosystem).

The type of paper used by the operation (e.g. for promotional material, stationary, toilets etc.) is a high profile example where significant worthwhile reductions in environmental impacts can be achieved. A strategy of internal reuse and recycle where possible, coupled with the use of products proven to be environmentally friendly (such as those carrying credible ecolabels) should be adopted.

For paper, ecolabels are likely to signify avoidance of chlorine-based bleaches, use of biodegradable inks and dyes, and use of wood from sustainable plantations.

Indicator measure: Ecolabel paper purchased (kg) pa/ Total paper purchased (kg) pa

Greenhouse gas reductions: Reduction in emissions associated with virgin raw material consumption.

Cleaning Chemicals Used

Objective: Reduce chemicals discharged into the environment.

The active (non-water) chemical ingredients of cleaning products (e.g. detergents, soaps, shampoos etc.) can end up in both wastewater (from toilets, washbasins, kitchens etc.) and stormwater systems (from cleaning bays, roofs, windows, car parks etc.). They are potential source of contamination of natural water bodies in terms of toxicity and disturbance of the natural balance of ecosystems (e.g. phosphates from detergents are known to contribute to eutrophication).

Along with an overall reduction in the gross amount of chemicals consumed per annum, increased use of ecolabeled biodegradable cleaning products would be a significant step towards overall reduction in chemical contamination of the environment.

Chemical usage is based on the relative amount of biodegradable chemical constituents in all solids and solutions used for cleaning.

Measure: Biodegradable cleaning chemicals used (kg) pa/Total cleaning chemicals used (kg) pa

Greenhouse gas reductions: Reduction in emissions from energy required for chemical production and water contamination treatment.

OPTIONAL SUSTALINABILITY INDICATORS

In addition to the indicators outlined above, a number of additional indicators can also be used. These may for example result in a higher level of certification if these sustainability indicators are accepted in addition to the sustainability indicators outlined above.

Operation Selected Indicator

Objective: Positive commitment to the local environment, society and economy.

Although optional, the operation can select an indicator form a list provided by the base station. The indicator should be considered particularly relevant to the operation and its environmental and/or social impact, and worthy of promotion. This may be operation or locality specific and should reflect a commitment to improving local issues.

Examples of possible indicators that can be selected are listed below:

Operation Selected Indicator measures: 002 sequested (tonnes) pa Total CO₂ generated (tonnes) pa

Renewable energy consumption pal Total energy consumption pa

Number of environmentally accredited operators and suppliers dealt with pa Total number of operators and suppliers dealt with pa

Monetary contributions made to sponsor conservation projects pa / Net turnover of operation pa

Area used for habitat conservation (ha) / Total property area (ha)

Value of consumable products purchased produced locally (within country) pa Total value of consumable products purchased pa

Monetary contributions made to sponsor local community activities pa/ Net turnover of operation pa

Operation Specified Indicator

Objective: Positive commitment to the local environment, society and economy

Although again optional, the operation can specify an indicator that does not appear in the list associated with the Operation Selected Indicator. Again this should be considered particularly relevant to its operation and its environmental impact, and worthy of promotion. It should reflect the operation's commitment to improving local issues (e.g. water quality, endangered species, habitat preservation, cultural heritage, community development etc.).

This indicator can be in addition to, or instead of, an Operation Selected Indicator.

ALTERNATIVE EXAMPLES

It will be appreciated that the sustainability indicators will be adapted depending on the industry to which the entity belongs. Accordingly, the indicator measures will typically vary to allow an appropriate value to he determined.

Furthermore, additional sustainability indicators can be defined and combined with those outlined above in a variety of ways to service the needs of different industries, such as:

Transport industries — including, airline industry, airports, bus, car and rail companies, or the like.

Community

Agriculture

Service industries — including restaurants, marinas, trailer parks, golf courses and the like.

Examples of some additional sustainability indicators suitable for use with different industries are set out below.

Stormwater Management

Objective: High quality of surface water discharged off-site.

The operation will occupy significant tracts of land over which a range of activities occur, some of which have direct impacts on stormwater quality, including oil spillages, oil leaks, application of chemicals (e.g. cleaning and pesticide) and the disturbance of vegetated areas.

Chemical and sediment runoff due to natural precipitation and hosing down activities (such as surface cleaning) should end-up in a stormwater management system, which will in turn be discharged off-site, often directly to natural watercourses (after traps), including aquifers, rather than into sewage treatment systems.

The requirement is to firstly have stormwater management and to then monitor the effectiveness of the operations on-site control (through contamination avoidance and treatment). The goal is to maintain discharged water at an acceptable level, which minimizes environmental impact (including seepage into aquifers). The indicator is the ratio of stormwater samples passing local regulatory standards to the number of samples taken.

Noise Nuisance

Objective: Minimize social disturbance from aircraft noise.

In recognition of the significant social nuisance value of noise, many operations now levy runway use charges against the noise associated with the aircraft. For example, the operation can differentiate between Chapter 2 and Chapter 3 planes by a significant difference in fees. Other issues that need to be considered we flight path keeping in terms of following preferential minimized noise impact routes and adherence to any flight curfews.

To gauge the overall success of noise minimization measures, the number of complaints and proven infringements to local regulations, to the number of plane departures is monitored.

Vehicle Management

Objective Encourage operation of vehicles performing to maximum efficiency.

The type of vehicle (size, engine capacity etc) is likely to be dictated by the local market, but the operation can still contribute to minimizing fuel consumption and associated emissions through ensuring regular maintenance as per the manufacturer's schedule.

The indicator is the ratio of tested exhaust emissions that pass local regulatory standards to the number of services carried out, Exhaust emissions are a good guide to the efficiency of combustion, and hence fuel consumption and level of harmful exhaust gases.

Air Quality

Objective: Improve air quality through reducing local emissions from energy consumption.

Gasses other than CO₂ and particulates are discharged into the air generated when fossil fuels are burnt to produce energy, agricultural crop residues are burnt, from industrial stack emissions etc. These include various nitrogen oxides (NOₓ), which can promote smog, which in turn can lead to respiratory problems. Sulphur dioxide (primarily from burning Sulphur containing coal or oil at power stations) can cause acid rain and particulates less than 10 gm in diameter (PM₁₀), lung and asthmatic problems. In terms of fuels, these impacts can be reduced by moving to alternatives (e.g. renewable or LPG) and more efficient, cleaner burning processes (including better exhaust gas cleaning, particularly at power stations). By using the same energy balance produced to assess the community's Energy Consumption, and a knowledge of the relative distribution of fuels among vehicle types (including aircraft and boats), using emission factors supplied by GREEN GLOBE, an estimate the amount of nitrogen oxides (NOₓ), sulphur dioxide (SO₂) and particulates (PM₁₀) produced can be made.

In addition to the direct burning of fuels, assessment of the impact of any crop burning and factory emissions (typically from stacks) also need to be made, as they can also have a significant impact.

Resource Conservation

Objective: Reduction in consumption of natural resources and impact on ecosystem biodiversity.

An active policy of careful consumption (e.g. minimizing wasteful practices) and purchasing supplies of materials from sources where they have been produced using environmentally sound ingredients and processes can be a major contributions by to resource conservation and biodiversity (i.e. through less impact on the balance of the local ecosystem).

It is recognized, however, that obtaining such detailed information across the entire community can be extremely difficult. As a consequence, this indicator, unlike the others, focuses on the lead agency by assessing its consumption and purchasing policies. The intention is that they are in an excellent position to "lead-by-example".

The quantity of paper used by the community's lead agency (e.g. for promotional material, stationary, toilets etc.) is a high profile example where significant worthwhile reduction in environmental impacts can be achieved, and a good demonstration example set. A strategy of internal reuse and recycle where possible, coupled to use of products that are proven to be environmentally friendly, such as those carrying credible ecolabels, should be adopted.

The use of materials that bear ecolabels is likely to signify avoidance of non-biodegradable chemicals which can cause significant harm to the local ecosystem. As a consequence, two primary uses of chemicals by the lead agency, cleaning agents and pesticides are assessed in terms of their "ecosensitivity".

Biodiversity

Objective: Conserve native habitats and biodiversity

The loss of biodiversity as a result of habitat destruction, resource depletion and pollution is a significant environmental problem, but an area's biodiversity can be extremely hard to quantify due to difficulties in obtaining credible data (e.g. the number of species present in an area, the size of an area's gene pool etc.), which in turn can make benchmarking performance problematic.

The indicator relates to the relationship between habitat and biodiversity conservation. The measure is based on the percentage of land set aside for native or regenerated native vegetation and designated for conservation. This provides a comparable quantified indication of the area of native habitat in a community and reflects the measures being taken by the destination to preserve these habitats and their associated biodiversity. As this measure also encourages re-vegetation programs, it can provide additional benefits through carbon sequestration.

Waterways Quality

Objective: Improve the quality of surface water, groundwater and aquatic habitats (including the sea). The application of chemicals (e.g. biocides and fertilizers) to the land, and the discharge of effluents and sediments to water bodies can lead to the degradation of natural water resources.

In order to assess the both the level of care taken to minimize these impacts on water resources and the subsequent monitoring of performance, the indicator is the proportion of all water samples taken in the area and analyzed that pass relevant statutory water standards.

Travel & Tourism

Objective: Assess the contribution that the local Travel & Tourism industry is making to protect the community's environment and resources.

The prime focus of the system is to encourage the Travel & Tourism industry to make, and benefit from, worthwhile improvements in key environmental and social performance areas.

The involvement of individual travel & tourism operations in credible environmental accreditation schemes is used, therefore, as a reflection of the level of commitment made by the local industry to the community's environment.

Chemicals Land Applied

Objective: Reduce artificial and non-biodegradable chemicals in the environment. Operations with large land tracts are typically high users of active chemicals (e.g. artificial fertilizers, herbicides and insecticides). Long-term application of these chemicals can lead to pollution of soils, surface water and groundwater, which can adversely affect the balance of ecosystems. A reduction in artificial fertilizers can be achieved by greater use of ecolabeled biodegradable products and alternative organic options, such as wastewater sludges and composted green waste. Artificial pesticide application can be also reduced by introducing integrated pest management programs. These programs develop locality specific solutions and can include practices such as using grass species suited to the locality, use of micro-organisms to fight pests and avoiding over-application of chemicals.

Chemical usage is based on the relative amount of biodegradable chemical constituents in all solids and solutions applied to the land.

### APPENDIX B

An example of the environmental effects which are considered when determining the sustainability indicators outlined above are set out below.

| | Environmental & Social Performance Areas | | | | | | | | |
|---|---|---|---|---|---|---|---|---|---|
| | | | | | Waste- | | | | Eco- |
| | Green- | Energy | | Fresh | water | Waste | Social & | Land use | system |
| | house | manage- | Air | water | manage- | minimi- | cultural | manage- | con- |
| | gases | ment | quality | resources | ment | sation | impact | ment | servation |
| Benchmarking (Earth Check ™) Indicators & | | | | | | | | | |
| Measures | | | | | | | | | |
| Sustainability Policy | X | X | X | X | X | X | X | X | X |
| Policy in place | | | | | | | | | |
| Energy Consumption: Energy consumed/ | X | X | X | | | X | | | X |
| Guest night or area under roof | | | | | | | | | |
| Potable Water Consumption: Water consumed/ | X | X | | X | X | X | | X | |
| Guest night or area under roof | | | | | | | | | |
| Solid Waste Production: Volume of waste/ | X | X | | | | X | | | X |
| Guest night or area under roof | | | | | | | | | |
| Social Commitment: Employees living within | X | X | X | | | | X | X | |
| 20 km/Total employees | | | | | | | | | |
| Resource Conservation: Ecolabel products | X | X | X | | X | X | X | X | X |
| purchased/Products purchased | | | | | | | | | |
| Cleaning Chemicals Used: Biodegradables | X | X | | X | X | X | | | X |
| used/Total chemicals used | | | | | | | | | |
| Optional Indicators & Measures | | | | | | | | | |
| Operation Selected Indicator: Measure selected | | | | | | | | | |
| from a predetermined list | | | | | | | | | |
| Operation Specified Indicator: Agreed measure | | | | | | | | | |
| put forward by the operation | | | | | | | | | |

### APPENDIX C

An example of an assessment report issued by a certification body called GREEN GLOBE is set out below.

Overview

This assessment was undertaken against benchmarking indicators for Accommodation developed for GREEN GLOBE. The indicators have been carefully selected to improve environmental and social performance in key performance areas such as the reduction of energy use and the reduction of waste and potable water use. The indicators are practical and customized for each sector. As a standard policy, GREEN GLOBE will continuously improve its indicators over time, but any changes will be introduced with plenty of warning to assist customers.

The following indicators apply to annual benchmarking of Accommodation in the GREEN GLOBE programme.

Sustainability policy: Policy in place

Energy consumption: Energy consumed/guest night or area under roof

Potable water consumption: Water consumed/guest night or area under roof

Solid waste production: Volume of waste/guest night or area under roof

Social commitment: Employees living within 20 kms/total employees

Resource conservation: Ecolabel products purchased/products purchased

Cleaning chemicals used: Biodegradables used/total chemicals used

Optional indicators are also provided for customers. They are opportunities for customizing the

Benchmarking for your individual operation. Optional indicators are encouraged, are recognized by GREEN GLOBE, but are not used for the final Benchmarking evaluation.

The data for the list of sustainability indicators set out above has been compiled by (name) in the format provided by GREEN GLOBE and has been submitted for assessment.

In order to meet the annual benchmarking requirements of GREEN GLOBE and have the right to use the GREEN GLOBE logo, all benchmarks should be at Baseline or better. Baseline performance is calculated at 5% above per capita average performance for a nation. Best practice is 30% above national average performance. In addition, GREEN GLOBE has sector specific Benchmarking information that it will continue to upgrade. Such information will help to refine the assessment of baseline and best practice over time. Such information will be made available in GREEN GLOBE published reports in the future.

THE BENCHMARKS

1. Sustainability policy: In Place

2. Energy consumption: ……………… GJ pa/guest night pa or area under roof

| | Environmental & Social Performance Areas | | | | | | | | |
|---|---|---|---|---|---|---|---|---|---|
| | | | | | Waste- | | | | Eco- |
| | Green- | Energy | | Fresh | water | Waste | Social & | Land use | system |
| | house | manage- | Air | water | manage- | minimi- | cultural | manage- | con- |
| | gases | ment | quality | resources | ment | sation | impact | ment | servation |
| Benchmarking (Earth Check ™) Indicators & | | | | | | | | | |
| Measures | | | | | | | | | |
| Sustainability Policy | X | X | X | X | X | X | X | X | X |
| Policy in place | | | | | | | | | |
| Energy Consumption: Energy consumed/ | X | X | X | | | X | | | X |
| Guest night or area under roof | | | | | | | | | |
| Potable Water Consumption: Water consumed/ | X | X | | X | X | X | | X | |
| Guest night or area under roof | | | | | | | | | |
| Solid Waste Production: Volume of waste/ | X | X | | | | X | | | X |
| Guest night or area under roof | | | | | | | | | |
| Social Commitment: Employees living within | X | X | X | | | | X | X | |
| 20 km/Total employees | | | | | | | | | |
| Resource Conservation: Ecolabel products | X | X | X | | X | X | X | X | X |
| purchased/Products purchased | | | | | | | | | |
| Cleaning Chemicals Used: Biodegradables | X | X | | X | X | X | | | X |
| used/Total chemicals used | | | | | | | | | |
| Optional Indicators & Measures | | | | | | | | | |
| Operation Selected Indicator: Measure selected | | | | | | | | | |
| from a predetermined list | | | | | | | | | |
| Operation Specified Indicator: Agreed measure | | | | | | | | | |
| put forward by the operation | | | | | | | | | |

3. Potable water consumption: ……….. Id. pa/guest night pa or area under roof

| | Environmental & Social Performance Areas | | | | | | | | |
|---|---|---|---|---|---|---|---|---|---|
| | | | | | Waste- | | | | Eco- |
| | Green- | Energy | | Fresh | water | Waste | Social & | Land use | system |
| | house | manage- | Air | water | manage- | minimi- | cultural | manage- | con- |
| | gases | ment | quality | resources | ment | sation | impact | ment | servation |
| Benchmarking (Earth Check ™) Indicators & | | | | | | | | | |
| Measures | | | | | | | | | |
| Sustainability Policy | X | X | X | X | X | X | X | X | X |
| Policy in place | | | | | | | | | |
| Energy Consumption: Energy consumed/ | X | X | X | | | X | | | X |
| Guest night or area under roof | | | | | | | | | |
| Potable Water Consumption: Water consumed/ | X | X | | X | X | X | | X | |
| Guest night or area under roof | | | | | | | | | |
| Solid Waste Production: Volume of waste/ | X | X | | | | X | | | X |
| Guest night or area under roof | | | | | | | | | |
| Social Commitment: Employees living within | X | X | X | | | | X | X | |
| 20 km/Total employees | | | | | | | | | |
| Resource Conservation: Ecolabel products | X | X | X | | X | X | X | X | X |
| purchased/Products purchased | | | | | | | | | |
| Cleaning Chemicals Used: Biodegradables | X | X | | X | X | X | | | X |
| used/Total chemicals used | | | | | | | | | |
| Optional Indicators & Measures | | | | | | | | | |
| Operation Selected Indicator: Measure selected | | | | | | | | | |
| from a predetermined list | | | | | | | | | |
| Operation Specified Indicator: Agreed measure | | | | | | | | | |
| put forward by the operation | | | | | | | | | |

4. Solid waste production: ………….. m³ pa/guest night pa or area under roof

| | Environmental & Social Performance Areas | | | | | | | | |
|---|---|---|---|---|---|---|---|---|---|
| | | | | | Waste- | | | | Eco- |
| | Green- | Energy | | Fresh | water | Waste | Social & | Land use | system |
| | house | manage- | Air | water | manage- | minimi- | cultural | manage- | con- |
| | gases | ment | quality | resources | ment | sation | impact | ment | servation |
| Benchmarking (Earth Check ™) Indicators & | | | | | | | | | |
| Measures | | | | | | | | | |
| Sustainability Policy | X | X | X | X | X | X | X | X | X |
| Policy in place | | | | | | | | | |
| Energy Consumption: Energy consumed/ | X | X | X | | | X | | | X |
| Guest night or area under roof | | | | | | | | | |
| Potable Water Consumption: Water consumed/ | X | X | | X | X | X | | X | |
| Guest night or area under roof | | | | | | | | | |
| Solid Waste Production: Volume of waste/ | X | X | | | | X | | | X |
| Guest night or area under roof | | | | | | | | | |
| Social Commitment: Employees living within | X | X | X | | | | X | X | |
| 20 km/Total employees | | | | | | | | | |
| Resource Conservation: Ecolabel products | X | X | X | | X | X | X | X | X |
| purchased/Products purchased | | | | | | | | | |
| Cleaning Chemicals Used: Biodegradables | X | X | | X | X | X | | | X |
| used/Total chemicals used | | | | | | | | | |
| Optional Indicators & Measures | | | | | | | | | |
| Operation Selected Indicator: Measure selected | | | | | | | | | |
| from a predetermined list | | | | | | | | | |
| Operation Specified Indicator: Agreed measure | | | | | | | | | |
| put forward by the operation | | | | | | | | | |

5. Social commitment: ……………… . Employees with primary address within 20km of operation/total employees

| | Environmental & Social Performance Areas | | | | | | | | |
|---|---|---|---|---|---|---|---|---|---|
| | | | | | Waste- | | | | Eco- |
| | Green- | Energy | | Fresh | water | Waste | Social & | Land use | system |
| | house | manage- | Air | water | manage- | minimi- | cultural | manage- | con- |
| | gases | ment | quality | resources | ment | sation | impact | ment | servation |
| Benchmarking (Earth Check ™) Indicators & | | | | | | | | | |
| Measures | | | | | | | | | |
| Sustainability Policy | X | X | X | X | X | X | X | X | X |
| Policy in place | | | | | | | | | |
| Energy Consumption: Energy consumed/ | X | X | X | | | X | | | X |
| Guest night or area under roof | | | | | | | | | |
| Potable Water Consumption: Water consumed/ | X | X | | X | X | X | | X | |
| Guest night or area under roof | | | | | | | | | |
| Solid Waste Production: Volume of waste/ | X | X | | | | X | | | X |
| Guest night or area under roof | | | | | | | | | |
| Social Commitment: Employees living within | X | X | X | | | | X | X | |
| 20 km/Total employees | | | | | | | | | |
| Resource Conservation: Ecolabel products | X | X | X | | X | X | X | X | X |
| purchased/Products purchased | | | | | | | | | |
| Cleaning Chemicals Used: Biodegradables | X | X | | X | X | X | | | X |
| used/Total chemicals used | | | | | | | | | |
| Optional Indicators & Measures | | | | | | | | | |
| Operation Selected Indicator: Measure selected | | | | | | | | | |
| from a predetermined list | | | | | | | | | |
| Operation Specified Indicator: Agreed measure | | | | | | | | | |
| put forward by the operation | | | | | | | | | |

6. Resource Conservation: …………… Ecolabel paper purchased (kg) pa/total paper purchased (kg) pa

| | Environmental & Social Performance Areas | | | | | | | | |
|---|---|---|---|---|---|---|---|---|---|
| | | | | | Waste- | | | | Eco- |
| | Green- | Energy | | Fresh | water | Waste | Social & | Land use | system |
| | house | manage- | Air | water | manage- | minimi- | cultural | manage- | con- |
| | gases | ment | quality | resources | ment | sation | impact | ment | servation |
| Benchmarking (Earth Check ™) Indicators & | | | | | | | | | |
| Measures | | | | | | | | | |
| Sustainability Policy | X | X | X | X | X | X | X | X | X |
| Policy in place | | | | | | | | | |
| Energy Consumption: Energy consumed/ | X | X | X | | | X | | | X |
| Guest night or area under roof | | | | | | | | | |
| Potable Water Consumption: Water consumed/ | X | X | | X | X | X | | X | |
| Guest night or area under roof | | | | | | | | | |
| Solid Waste Production: Volume of waste/ | X | X | | | | X | | | X |
| Guest night or area under roof | | | | | | | | | |
| Social Commitment: Employees living within | X | X | X | | | | X | X | |
| 20 km/Total employees | | | | | | | | | |
| Resource Conservation: Ecolabel products | X | X | X | | X | X | X | X | X |
| purchased/Products purchased | | | | | | | | | |
| Cleaning Chemicals Used: Biodegradables | X | X | | X | X | X | | | X |
| used/Total chemicals used | | | | | | | | | |
| Optional Indicators & Measures | | | | | | | | | |
| Operation Selected Indicator: Measure selected | | | | | | | | | |
| from a predetermined list | | | | | | | | | |
| Operation Specified Indicator: Agreed measure | | | | | | | | | |
| put forward by the operation | | | | | | | | | |

7. Cleaning chemicals used: …………... Biodegradable cleaning chemicals used pa/total cleaning chemicals used (kg) pa

| | Environmental & Social Performance Areas | | | | | | | | |
|---|---|---|---|---|---|---|---|---|---|
| | | | | | Waste- | | | | Eco- |
| | Green- | Energy | | Fresh | water | Waste | Social & | Land use | system |
| | house | manage- | Air | water | manage- | minimi- | cultural | manage- | con- |
| | gases | ment | quality | resources | ment | sation | impact | ment | servation |
| Benchmarking (Earth Check ™) Indicators & | | | | | | | | | |
| Measures | | | | | | | | | |
| Sustainability Policy | X | X | X | X | X | X | X | X | X |
| Policy in place | | | | | | | | | |
| Energy Consumption: Energy consumed/ | X | X | X | | | X | | | X |
| Guest night or area under roof | | | | | | | | | |
| Potable Water Consumption: Water consumed/ | X | X | | X | X | X | | X | |
| Guest night or area under roof | | | | | | | | | |
| Solid Waste Production: Volume of waste/ | X | X | | | | X | | | X |
| Guest night or area under roof | | | | | | | | | |
| Social Commitment: Employees living within | X | X | X | | | | X | X | |
| 20 km/Total employees | | | | | | | | | |
| Resource Conservation: Ecolabel products | X | X | X | | X | X | X | X | X |
| purchased/Products purchased | | | | | | | | | |
| Cleaning Chemicals Used: Biodegradables | X | X | | X | X | X | | | X |
| used/Total chemicals used | | | | | | | | | |
| Optional Indicators & Measures | | | | | | | | | |
| Operation Selected Indicator: Measure selected | | | | | | | | | |
| from a predetermined list | | | | | | | | | |
| Operation Specified Indicator: Agreed measure | | | | | | | | | |
| put forward by the operation | | | | | | | | | |

8. Optional Indicators:

9. CEO Endorsement of information: In Place

Conclusions and Recommendation

"Accommodation Name" has passed the GREEN GLOBE requirements to become recognized as GREEN GLOBE Accommodation for the next 12 months.

Retention of this status in 12 months is dependent on (text as appropriate for each individual case.)

1. (canceled).

2. (canceled).

3. (canceled).

4. (canceled).

5. (canceled).

6. (canceled).

7. (canceled).

8. (canceled).

9. (canceled).

10. (canceled).

11. (canceled).

12. (canceled).

13. (canceled).

14. (canceled).

15. (canceled).

16. (canceled).

17. (canceled).

18. (canceled).

19. (canceled).

20. (canceled).

21. (canceled).

22. (canceled).

23. (canceled).

24. (canceled).

25. (canceled).

26. (canceled).

27. (canceled).

28. (canceled).

29. (canceled).

30. (canceled).

31. (canceled).

32. (canceled).

33. (canceled).

34. (new): A method for assessing the sustainability performance of an entity, wherein the method comprises:
a) monitoring an operation of the entity;
b) selecting at least one sustainability indicator, wherein the sustainability indicator is measure of the operation of the entity in a particular environmental area;
c) comparing the selected sustainability indicator to a first threshold, wherein the first threshold is a predetermined value representing a level of efficiency relative to the selected sustainability indicator; and,
d) generating an indication of the sustainability performance in accordance with the results of the comparison.

35. (new): The method according to claim 35, wherein the sustainability indicator comprises at least one component value, and wherein the sustainability indicator that includes at least one component value is determined based on a weighted sum of the at least one component values.

36. (new): The method according to claim 35, wherein the sustainability indicator comprises at least one of:
a) an energy indicator representing an amount of energy used by the entity;
b) a water indicator representing an amount of water used by the entity; and,
c) a waste indicator representing an amount of waste generated by the entity.

37. (new): The method according to claim 37, wherein the energy indicator comprises at least one energy component value, and wherein the energy component value represents the amount of energy used from an energy source.

38. (new): The method according to claim 38, wherein the energy indicator is determined by:
a) determining an energy component based on the amount of energy used from a source;
b) multiplying each energy component by a parameter to determine a modified component, wherein each parameter is predetermined in accordance with the energy source; and,
c) summing each of the modified energy components.

39. (new): The method according to claim 35, wherein the sustainability indicator comprises at least one of:
a) a social commitment indicator representing an impact of the entity on a local community;
b) a resource conservation indicator representing an amount of ecological products used; and,
c) a chemical indicator representing an amount of chemicals used.

40. (new): The method according to claim 40, wherein the social commitment indicator is a ratio of a number of employees of the entity living within a predetermined distance of the entity to a total number of employees of the entity.

41. (new): The method according to claim 40, wherein the resource conservation indicator is a ratio of a number of ecolabel products used to a total number of products used.

42. (new): The method according to claim 40, wherein the chemical indicator is a ratio of an amount of biodegradable chemicals used to a total amount of chemicals used.

43. (new): The method according to claim 35, wherein the sustainability indicator further comprises the presence and implementation of an environmental policy.

44. (new): The method according to claim 35, wherein in response to a successful comparison in which the selected sustainability indicator is greater than or equal to the first threshold, the method further comprises:
a) comparing the sustainability indicator to a second threshold, wherein the second threshold is a predetermined value representing a level of efficiency greater than the level of efficiency represented by the first threshold; and,
b) generating a second indication of the sustainability performance in accordance with the results of the second comparison.

45. (new): The method according to claim 35, wherein the method further comprises determining whether the comparison is successful, wherein a successful comparison is generated by the selected sustainability indicator being greater than or equal to the first threshold.

46. (new): The method according to claim 46, wherein the method further comprises certifying the entity in response to a successful comparison.

47. (new): The method according to claim 44, wherein the method further comprises:
a) comparing the selected sustainability indicator to a second threshold, wherein the second threshold is a predetermined value representing a level of efficiency greater than the level of efficiency represented by the first threshold; and,
b) determining whether the comparison of the sustainability indicator to the second threshold is successful, wherein a successful comparison is generated by the sustainability indicator being greater than or equal to the second threshold.

48. (new): The method according to claim 35, wherein the first threshold is determined in accordance with at least one of:
a) a location of the entity; and,
b) a nature of the entity's operation.

49. (new): The method according to claim 35, wherein the first threshold is determined in accordance with an average of the at least one selected sustainability indicator determined for a predetermined sample number of entities.

50. (new): The method according to claim 50, wherein the first threshold is 5% higher than the average of the at least one selected sustainability indicator.

51. (new): The method according to claim 50, wherein the first threshold is 30% higher than the average of the at least one selected sustainability indicator.

52. (new): The method according to claim 35, wherein the monitoring of the entity is performed by the entity or by a member of the entity.

53. (new): The method according to claim 35, wherein the monitoring of the entity is performed by an individual accredited by predetermined standards.

54. (new): The method according to claim 35, wherein the method further comprises generating a report, and wherein the report indicates the sustainability performance of the entity by indicating information comprising the results of the comparison.

55. (new): The method according to claim 55, wherein the report further indicates improvements that could be made to the operation of the entity to thereby enhance the sustainability performance of the entity.

56. (new): The method according to claim 35, wherein the method is performed using a processing system comprising:
a) input means adapted to receive the selected sustainability indicator;
b) memory means adapted to store data representative of the first threshold; and,
c) a processor, wherein the processor is adapted to:
i) compare the selected sustainability indicator to the first threshold; and,
ii) generate the indication of the sustainability performance in accordance with the results of the comparison.

57. (new): The method according to claim 57, wherein the method further comprises causing the processor to store entity data in the memory means, and wherein the entity data comprises:
a) an identity of the entity; and,
b) the sustainability indicator.

58. (new): The method according to claim 58, wherein the entity data further comprises:
a) a location of the entity; and,
b) a nature of the entity's operation.

59. (new): The method according to claim 58, wherein the method further comprises determining the first threshold in accordance with the entity data stored in the store.

60. (new): A system for assessing the sustainability performance of an entity, wherein the system comprises:
a) input means adapted to receive at least one sustainability indicator, wherein the sustainability indicator is a measure of the operation of the entity in a particular environmental area;
b) memory means adapted to store a first threshold, wherein the first threshold is a predetermined value representing a level of efficiency relative to the sustainability indicator; and,
c) a processor, wherein the processor is adapted to:
i) compare the sustainability indicator to the first threshold; and,
ii) generate an indication of the sustainability performance in accordance with the results of the comparison.

61. (new): The system according to claim 61, wherein the input means comprises a remote processing system coupled to the system via a communications network.

62. (new): The system according to claim 61, wherein the system further comprises a number of interconnected processing systems.

63. (new): A computer program product for assessing the sustainability performance of an entity, wherein the computer program product includes computer executable code which when executed by a suitably programmed processor causes the processor to perform the method of claim 35.
